(19) United States
(12) Patent Application Publication
(10) Pub. No.: US 2002/0015518 A1
(43) Pub. Date: Feb. 7, 2002

(54) Semiconductor wafer pattern shape evaluation method and device

(76) Inventor: Ryoichi Matsuoka, Chiba-shi (JP)

Correspondence Address: ADAMS & WILKS, ATTORNEYS AND COUNSELORS AT LAW, 31st FLOOR, 50 BROADWAY, NEW YORK, NY, 10004, US

(21) Appl. No.: 09/903,601

(22) Filed: Jul. 12, 2001

(30) Foreign Application Priority Data
Jul. 14, 2000 (JP) 2000-214847

(51) Int. Cl. G06K 9/00; G06K 9/48

(52) U.S. Cl. 382/145; 382/199

(57) ABSTRACT

Line segment extraction of a subject pattern is carried out based on an SEM image data DBL of a pattern to be subjected to evaluation, so as to obtain SEM line segment data DC. A superimposition displacement distance is then obtained based on CAD line segment data DD corresponding to the subject pattern and SEM line segment data DC, evaluation of a subject pattern is performed in two dimensions, and resulting evaluation value data DE is displayed graphically.

### BACKGROUND OF THE INVENTION

1. Field of the Invention

The present invention relates to a semiconductor wafer pattern shape evaluation method and device, and more particularly relates to a method and device for evaluating in a two-dimensional manner a pattern shape by comparing a pattern actually formed on a semiconductor wafer and an estimated pattern shape.

2. Description of the Prior Art

In the related art, when it has been necessary to perform inspections as to whether or not the shape of a pattern formed on a wafer is a predicted shape, the width of patterns and the length of intervals between patterns are measured using critical dimension SEM(CDSEM) and the shape of a finished pattern is then evaluated based on the results for measuring these lengths.

The related technology described above is technology that evaluates finished products on a one dimensional level by measuring the widths and intervals between patterns formed on a wafer, but what is really required is two dimensional shape evaluation where the finish of a desired pattern shape can be evaluated to seethe degree of collapse of the completed pattern.

However, reliable technology for evaluating the finish of a pattern formed on a wafer in two dimensions is yet to be established.

Further, pattern evaluation using critical dimension SEM(CDSEM)can only be applied to limited portions on the wafer and checking of the pattern finish cannot be carried out at arbitrary locations on the wafer.

### SUMMARY OF THE INVENTION

It is therefore an object of the present invention to provide a semiconductor wafer pattern shape evaluating method and device capable of evaluating the finish at arbitrary locations of a pattern formed on a wafer in two dimensions.

In a feature of the present invention for resolving the aforementioned problems, there is provided a device for evaluating the shape of a pattern formed on the semiconductor wafer in accordance with CAD data, comprising: designating means for designating, using CAD data, a subject pattern to be evaluated; means for acquiring CAD line segment data corresponding to SEM image data for the subject pattern and the subject pattern in response to the designating means; means for performing line segment extraction for the subject pattern based on SEM image data in order to obtain SEM line segment data; evaluation processing means for subjecting the subject pattern to two-dimensional evaluation processing based on the CAD line segment data and the SEM line segment data; and displaying means for displaying evaluation results from the evaluation processing means.

Evaluation items can be pattern end points, width, spacing, or surface area, etc. The two-dimensional evaluation processing includes a process of calculating superimposition displacement distances between CAD line segment data and SEM line segment data for noted line segments of a subject pattern. In this case, the obtained superimposition displacement distances are compared with prescribed reference values and evaluation values corresponding to these superimposition displacement distances are obtained.

When evaluation values with levels assigned by the evaluation processing means are obtained, the evaluation values can be displayed at the display means using colors or patterns etc. predefined for each level. In this case, evaluation values for each location of the subject pattern can be displayed at corresponding locations on the wafer map. According to this construction, problematic locations and their associated evaluation values can be displayed in such a manner as to be easily understood at a glance.

According to the present invention, there is provided a method for evaluating the shape of a pattern formed on a semiconductor wafer in accordance with CAD data, comprising a step of extracting line segments for a subject pattern based on SEM image data for the subject pattern to be evaluated and acquiring SEM line segment data, and evaluating the subject pattern in two dimensions based on CAD line segment data corresponding to the subject pattern and SEM line segment data.

Evaluation items can be pattern end points, width, spacing, or surface area, etc. The two-dimensional evaluation processing evaluates based on superimposition displacement distances between CAD line segment data and SEM line segment data for noted line segments of a subject pattern. In this case, the obtained superimposition displacement distances are compared with prescribed reference values and evaluation values corresponding to these superimposition displacement distances can be obtained.

The evaluation values obtained in the above manner are assigned levels, and the evaluation values can then be displayed using colors and patterns predefined for each level. In this case, evaluation values for each location of the subject pattern can be displayed at corresponding locations on the wafer map.

### BRIEF DESCRIPTION OF THE DRAWINGS

FIG. 1 is a block view showing an example of an embodiment of a semiconductor wafer pattern shape evaluating device of the present invention.

FIG. 2 is a flowchart showing the navigation program shown in FIG. 1.

FIG. 3 is a block view showing the configuration of the evaluation calculating unit shown in FIG. 1.

FIG. 4 is a view showing an example of a display state occurring at the display unit shown in FIG. 1.

FIG. 5 is a view showing a further example of a display state occurring at the display unit shown in FIG. 1.

### DETAILED DESCRIPTION OF THE PREFERRED EMBODIMENTS

The following is a detailed description, with reference to the drawings, of an example of an embodiment of the present invention.

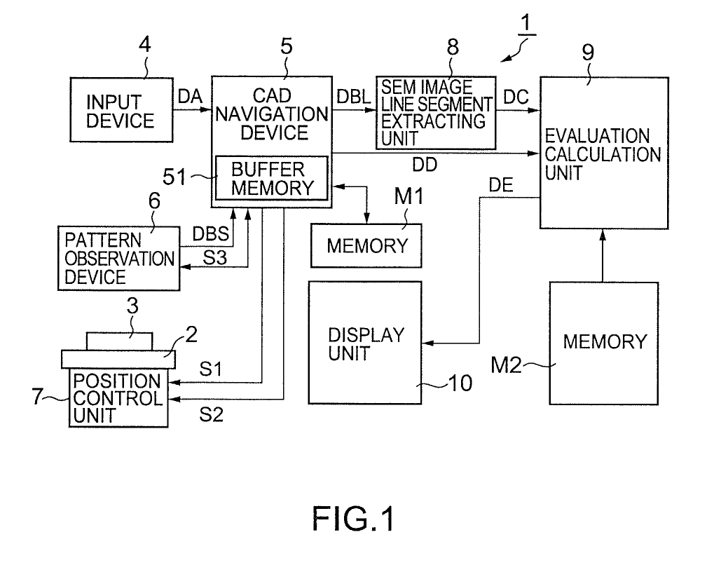

FIG. 1 is a block view showing an example of an embodiment of a semiconductor wafer pattern shape evaluating device of the present invention. A pattern shape evaluating device 1 is a device for evaluating whether or not the shape of a pattern (not shown) formed on a semiconductor wafer 3 installed on a stage 2 based on CAD data is accurately formed in accordance with the CAD data.

As shown by numeral 4, an input device for inputting designation data for designating a subject pattern, of the pattern of the semiconductor wafer 3, to be evaluated, is also provided, and designation data DA inputted using the input device 4 is transmitted to a CAD navigation device 5. The CAD navigation device 5 is for obtaining SEM image data of a subject pattern from a pattern observation device 6 by lining up the observational field of view of the pattern monitoring device 6 with a position of a subject pattern on the semiconductor wafer 3 designated by the designation data DA. This is comprised of a prescribed navigation program installed on a well known computing device including a microcomputer. The CAD navigation device 5 operates according to this navigation program.

Automatic positional alignment to the field of view of the pattern observation device 6 necessary for monitoring is carried out with a high degree of precision by enlarging a subject pattern formed on the semiconductor wafer 3 in this manner a number of times.

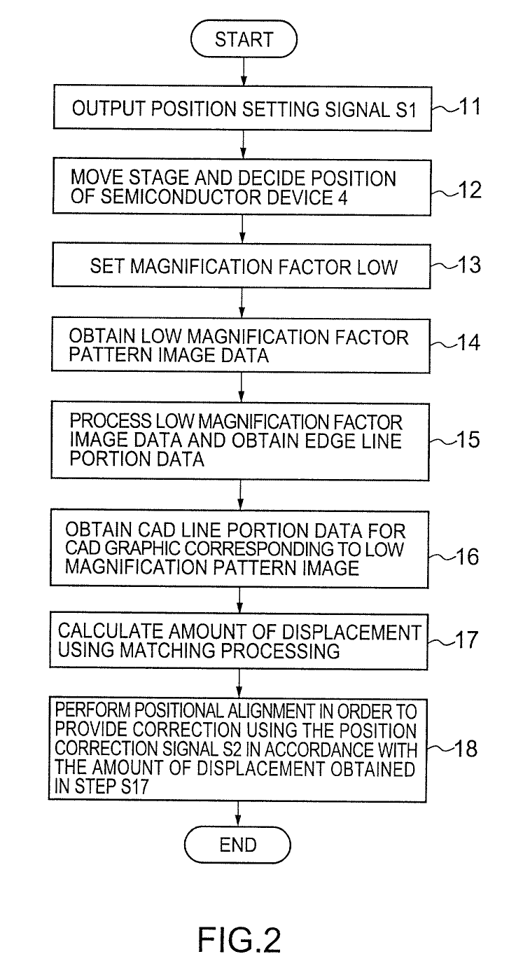

FIG. 2 shows a flowchart of the navigation program. In the following, a description is given of the navigation operation for automatically positioning the observational field of view using the CAD navigation device 5 with reference to FIG. 2.

When the subject pattern of the pattern for the semiconductor wafer 3 is designated using the input device 4, a position setting signal S1 is outputted from the CAD navigation device 5 in response to this subject pattern designation (step 11). In step 12, a position control unit 7 moves the stage 2 in response to the position setting signal S1. The semiconductor wafer 3 is then positioned relatively with respect to the pattern observation device 6 in such a manner that the center of the observational field of view of the pattern observation device 6 coincides with the center of observation of the subject pattern designated at this time.

Next, in step 13, magnification observation of the pattern observation device 6 is set to be an appropriately low magnification so that the center of observation of the designated subject pattern is within the observational field of view of the pattern monitoring device 6 as instructed by the magnification setting signal S3 outputted from the CAD navigation device 5. With regards to the low magnification factor, for example, even when a predicted position setting error is predicted in the positioning of the stage 2, the magnification factor can be decided by taking stage precision of the stage 2 into consideration, so that the observation center of the designated subject pattern is placed in the observation line of view of the pattern observation device 6.

In step 14, image data DBS expressing a low magnification SEM image for a subject pattern obtained under the aforementioned monitoring conditions by the pattern monitoring device 6 at the CAD navigation device 5 is captured and the obtained image data DBS is stored in the buffer memory 51 within the CAD navigation device 5.

In Step 15, image data DBS stored in the buffer memory 51 is processed by a well known method to perform edge extraction. As a result, edge line segment data for the subject pattern is obtained based on the image data DBS.

Next, in step 16, CAD graphics data corresponding to the image data DBS obtained in step 14 is read from memory M1 storing the CAD data and is stored in the buffer memory 51. The CAD graphics data describes the pattern design drawing having its center point at the observation center of the pattern observation device 6. The CAD line segment data is obtained based on the read out CAD graphics data. The CAD line segment data describes the line segment of the pattern according to the CAD data.

Also, in Step 17, matching processing is performed, where the edge line segment data is compared to the CAD line segment data. As a result, the offset amount between the observation center and the center of the observational field of view of the pattern observation device 6 is calculated. The offset amount is calculated as an amount of image shift within the observation plane.

In Step 18, according to the offset amount obtained in Step 17, a position correction signal S2 is outputted to move the stage 2 to align the observation center and the center of the observational field of view of the pattern observation device 6. The position control unit 7 then operates in accordance with the position correction signal S2, and as a result, the observation center is aligned with the center of the observational field of view of the pattern observation device 6.

As described above, using the CAD navigation device 5, first, the offset amount between the observation center of the low magnification SEM image and the actual center of the observational field of view of the pattern observation device 6 is calculated. Regarding the offset amount as the positioning error according to the stage precision, the stage 2 is moved by the offset amount, and therefore the observational field of view of the pattern observation device 6 can be positioned precisely at the subject pattern of the pattern of the semiconductor wafer 3. Also, each operation for positioning described above may be carried out by moving the pattern observation device 6.

After the observational field of view of the pattern observation device 6 is accurately positioned at the subject pattern of the pattern on the semiconductor wafer 3, the CAD navigation device 5 sets the observation magnification of the pattern observation device 6 to a required high rate of magnification using the multiplication setting signal S3. The SEM image data DBL for the subject pattern is then outputted from the pattern observation device 6 in this state and the SEM image data DBL is transmitted to an SEM image line segment extracting unit 8.

Line segment extraction processing of the subject pattern expressed by the SEM image data DBL inputted to the SEM image line segment extracting unit 8 is then implemented and SEM line segment data DC constituting line segment data for the subject pattern is outputted.

The CAD navigation device 5 then reads CAD data stored in the memory M1, and calculates and outputs CAD line segment data DD corresponding to the subject pattern based on this CAD data. SEM line segment data DC and CAD line segment data DD are inputted to an evaluation calculation unit 9 and two-dimensional evaluation processing for evaluating this subject pattern in two dimensions is implemented.

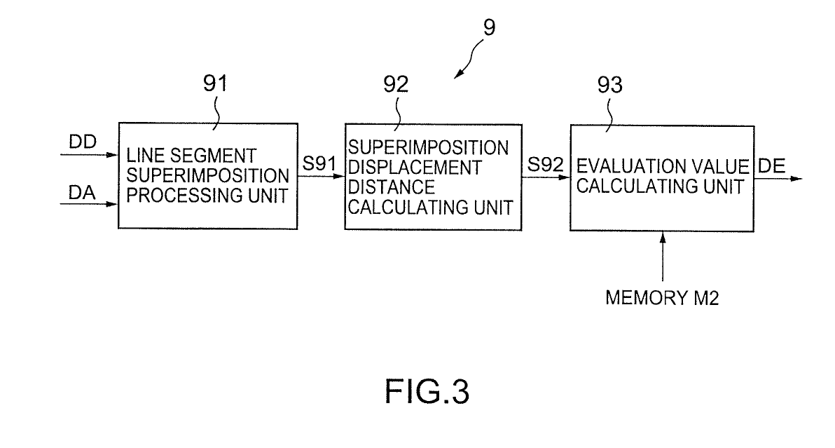

A block view of the structure of the evaluation calculation unit 9 is shown in FIG. 3. The evaluation calculation unit 9 comprises a line segment superimposition processing unit 91 for receiving and performing superimposition processing on the CAD line segment data DD and the SEM line segment data DC, and a superimposition displacement distance calculating unit 92 for calculating superimposition displacement distances for evaluation items, taking end points of the subject pattern, width, and distances between neighboring patterns as evaluation items, based on superimposition data S91 from the line segment superimposition processing unit 91.

Evaluation calculation results for each evaluation item from the superimposition displacement distance calculating unit 92 are outputted as evaluation results data S92 expressed numerically and inputted to an evaluation value calculating unit 93. At the memory M2, evaluation result data S92 inputted as numerical values is stored in a displacement evaluation value table for performing evaluation in five levels. At the evaluation calculation unit 9, a five level evaluation is then performed on the finish of each evaluation item of the subject pattern by comparing the inputted numeric values with the displacement amount evaluation value table. Evaluation value data DE showing these evaluation results is then outputted.

Returning to FIG. 1, at the evaluation calculating unit 9, the evaluation data DE acquired as described above is sent to a display unit 10. Results for evaluation of the pattern of the semiconductor wafer 3 are then displayed at the display unit 10 based on the evaluation value data DE.

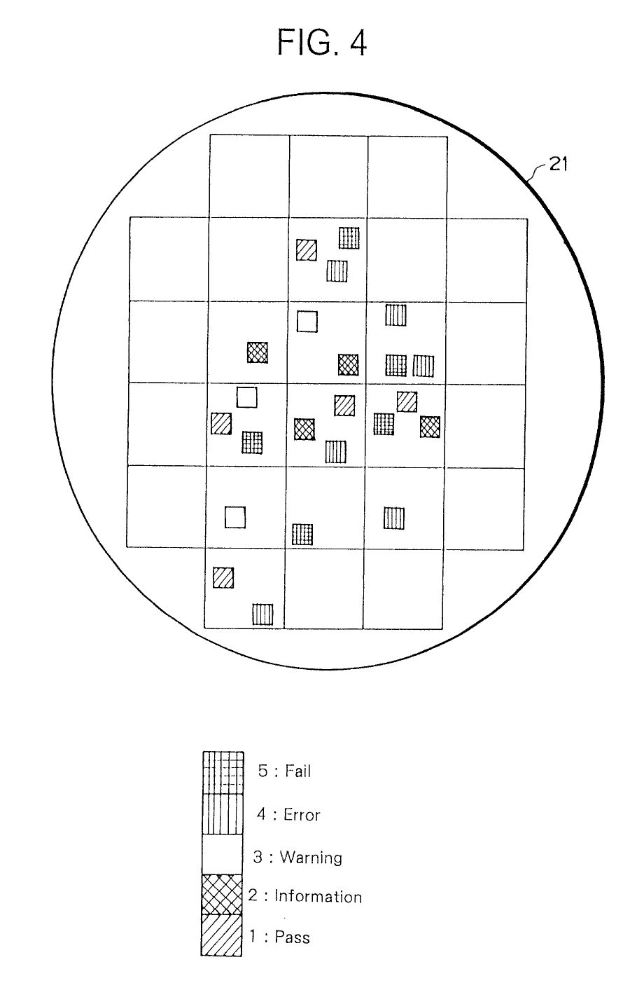

FIG. 4 shows an example of a display screen shown at the display unit 10. Numeral 21 is schematic view of a pattern schematically showing the pattern shape of the surface of the semiconductor wafer 3. In the schematic view of the pattern 21, an example is shown where there are 26 segments partitioned on the semiconductor wafer 3. A prescribed pattern is formed at each of the segments in accordance with the CAD data but in FIG. 4, displaying of these patterns is omitted. With the evaluation results for the pattern formed at each segment of the semiconductor wafer 3, patterns, of five patterns prepared so as to correspond to the five levels of evaluation shown in FIG. 4, corresponding to evaluations results, are displayed at corresponding locations within the pattern schematic view 21. A configuration is also possible where display is performed using appropriate shaped marks using five colors in place of the five types of pattern.

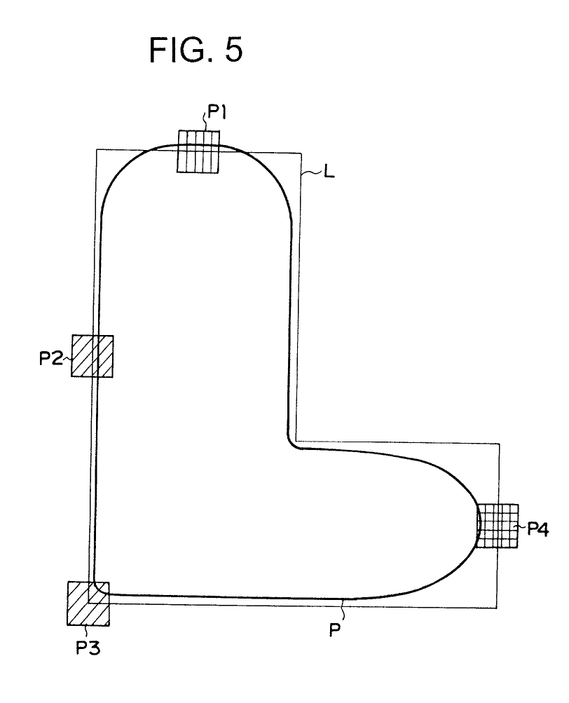

An example of a separate display occurring at the display unit 10 is shown in FIG. 5. Here, evaluation results for each of parts P1 to P4 of the subject pattern P are displayed using the five level display pattern of FIG. 4, with displaying being such that the evaluation results are displayed with a pattern assigned at each of the parts P1 to P4. A fine line L is then displayed on the design in accordance with the CAD data.

According to the display states in FIG. 4 and FIG. 5, problematic locations and their associated evaluation values can be displayed in such a manner as to be easily understood at a glance, which is beneficial. As a result, the missing of defects and erroneous confirmations can be substantially reduced.

According to the pattern forming evaluation device 1, collapsing etc. of the pattern formed on the wafer can be quantitavely evaluated. In addition to improving the reliability of quality management in the production process, improved designation in each of the processes of design, mask manufacture, exposure devices, defect detection devices and processes etc. can be achieved.

According to the present invention, collapsing etc. of the pattern formed on the semiconductor wafer 3 can be quantitavely evaluated. In addition to improving the reliability of quality management in the production process, improved designation in each of the processes of design, mask manufacture, exposure devices, defect detection devices and processes etc. can be achieved.

Further, problematic locations and their associated evaluation values can be easily understood at a glance by displaying evaluation results in an easy-to-understand manner using patterns and colors. This provides ease of use and dramatically reduces the missing of defects and erroneous confirmations.

What is claimed is:

1. A wafer pattern shape evaluation device for evaluating a pattern shape formed on a semiconductor wafer in accordance with CAD data, comprising:
designating means for designating, using CAD data, a subject pattern to be evaluated;
means for acquiring CAD line segment data corresponding to SEM image data for the subject pattern and the subject pattern in response to the designating means;
means for performing line segment extraction for the subject pattern based on SEM image data in order to obtain SEM line segment data;
evaluation processing means for subjecting the subject pattern to two-dimensional evaluation processing based on the CAD line segment data and the SEM line segment data;
displaying means for displaying evaluation results from the evaluation processing means;

2. The semiconductor wafer pattern shape evaluation device of claim 1, wherein the CAD line segment data is made based on data corresponding to the subject pattern of the CAD data.

3. The semiconductor wafer pattern shape evaluation device of claim 1, wherein evaluation items occurring in two dimensional evaluation processing comprise at least one of pattern endpoints, width, interval and surface area.

4. The semiconductor wafer pattern shape evaluating device of claim 1, wherein the two-dimensional evaluation processing includes a process of calculating super imposition displacement distances between CAD line segment data and SEM line segment data for noted line segments of a subject pattern.

5. The semiconductor wafer pattern shape evaluation device of claim 1, wherein the superimposition displacement distance is compared with a prescribed reference value, with evaluation values corresponding to the superimposition displacement distances being taken as the display evaluation results.

6. The semiconductor wafer pattern shape evaluation device of claim 1, wherein the superimposition displacement distance is compared with a prescribed reference value, with evaluation values corresponding to the superimposition displacement distances being assigned levels and being taken as the display evaluation results.

7. The semiconductor wafer pattern shape evaluating device of claim 1, wherein the superimposition displacement distance is compared with a prescribed reference value, evaluation values corresponding to superimposition displacement distances are assigned levels, with the evaluation values being displayed at the display means using colors or patterns etc. predefined for each level.

8. The semiconductor wafer pattern shape evaluating device of claim 7, wherein evaluation values for each location of the subject pattern are displayed at corresponding locations on a wafer map.

9. A method for evaluating a pattern shape formed on a semiconductor wafer in accordance with CAD data, comprising the step of:
extracting line segments for a subject pattern based on SEM image data for the subject pattern to be evaluated and acquiring SEM line segment data, and evaluating the subject pattern in two dimensions based on CAD line segment data corresponding to the subject pattern and SEM line segment data.

10. The semiconductor wafer pattern shape evaluation method of claim 9, wherein the CAD line segment data is made based on data corresponding to the subject pattern of the CAD data.

11. The semiconductor wafer pattern shape evaluation method of claim 10, wherein evaluation items occurring in two-dimensional evaluation comprise at least one of pattern endpoints, width, interval and surface area.

12. The semiconductor wafer pattern shape evaluating method of claim 10, wherein the two-dimensional evaluation processing includes a process of calculating superimposition displacement distances between CAD line segment data and SEM line segment data for noted line segments of a subject pattern.

13. The semiconductor wafer pattern shape evaluation method of claim 12, wherein the superimposition displacement distance is compared with a prescribed reference value, with evaluation values corresponding to the superimposition displacement distances being taken as the display evaluation results.

14. The semiconductor wafer pattern shape evaluation method of claim 12, wherein the superimposition displacement distance is compared with a prescribed reference value, with evaluation values corresponding to the superimposition displacement distances being assigned levels and being taken as the display evaluation results.

15. The semiconductor wafer pattern shape evaluating method of claim 1, wherein the superimposition displacement distance is compared with a prescribed reference value, evaluation values corresponding to superimposition displacement distances are assigned levels, with the evaluation values being displayed using colors or patterns etc. predefined for each level.

16. The semiconductor wafer pattern shape evaluating method of claim 9, wherein evaluation values for each location of the subject pattern are displayed at corresponding locations on a wafer map.
